(19) United States
(12) Patent Application Publication
(10) Pub. No.: US 2025/0148042 A1
(43) Pub. Date: May 8, 2025

(54) OPTIMIZING FUNCTIONS FOR TARGET PROCESSORS BY SEARCHING THROUGH CANDIDATE COMPUTER PROGRAMS

(71) Applicant: Google LLC, Mountain View, CA (US)

(72) Inventors: Esteban Alberto Real, Sunnyvale, CA (US); Mirko Rossini, Brooklyn, NY (US); Connal Joseph de Souza, New York, NY (US); Manav Garg, Milpitas, CA (US)

(21) Appl. No.: 18/940,773

(22) Filed: Nov. 7, 2024

Related U.S. Application Data
(60) Provisional application No. 63/596,947, filed on Nov. 7, 2023.

(51) Int. Cl. G06F 17/11

(52) U.S. Cl. CPC G06F 17/11

(57) ABSTRACT

Methods, systems, and apparatus, including computer programs encoded on computer storage media, for optimizing a target function for execution on a target processor. In particular, the target function is optimized by searching through candidate computer programs that each represent an approximation of the target function.

### CROSS-REFERENCE TO RELATED APPLICATION

This application claims priority to U.S. Provisional Application No. 63/596,947, filed on Nov. 7, 2023. The disclosure of the prior application is considered part of and is incorporated by reference in the disclosure of this application.

### BACKGROUND

This specification relates to function optimization and, in particular, to optimizing functions for execution on a target processor.

The target processor can generally be any appropriate computer processor that performs computations using memory and registers.

### SUMMARY

This specification describes a system implemented as computer programs on one or more computers in one or more locations that optimizes a target function for execution on a target processor. “Optimizing” a target function generally refers to determining a set of operations that, when executed by the target processor, will cause the target processor to generate outputs that approximate the target function with high precision while optimizing the execution, e.g., optimizing the speed or latency of the execution.

The target processor can generally be any appropriate computer processor that performs computations using memory and registers. For example, the target processor can be a central processing unit (CPU) with a particular computer architecture, e.g., an x86 CPU or a RISC CPU. As another example, the target processor can be an application-specific integrated circuit (ASIC).

The subject matter described in this specification can be implemented in particular embodiments so as to realize one or more of the following advantages.

Computers calculate functions, e.g., transcendental functions, by composing a limited set of instructions provided by the hardware, such as additions and multiplications, in order to generate an approximation of the underlying function. These approximation methods have generally been developed with little consideration given to modern computation issues like floating-point rounding, compiler effects, or hardware pipelining that can dramatically affect the speed and precision of executing a given function on a target processor.

This specification generally describes searching for an optimized function by searching a space of possible computer programs, at scale, to discover fast solutions with almost perfect floating-point precision.

For example, when searching for a function to compute exponentials, the described techniques identify a program that, with less than 1 unit-in-the-last-place (ULP) of error, can run roughly four times faster than mathematical alternatives by exploiting compiler optimization paths and subroutine reuse.

In particular, because the search process optimizes directly for floating-point computation on the hardware and compiler of interest, i.e., measures how compiled programs representing approximations of the function would execute on the target processor when compiled using a compiler for the target process, the discovered programs are able to efficiently account for modern computation issues like floating-point rounding, compiler effects, and hardware pipelining in order to accurately and quickly perform the computation required for the target function.

As a result, after the system has determined a final computer program, the final computer program can be compiled and executed by the target processor with improved performance, e.g., with reduced latency or increased throughput, relative to existing approximations of the target function and with comparable or better precision than the existing approximations.

The details of one or more embodiments of the subject matter of this specification are set forth in the accompanying drawings and the description below.

Other features, aspects, and advantages of the subject matter will become apparent from the description, the drawings, and the claims.

### BRIEF DESCRIPTION OF THE DRAWINGS

FIG. 1 is a diagram of an example function optimization system.

FIG. 2 is a flow diagram of an example process for generating a computer program.

FIG. 3 is a flow diagram of an example process for performing the search operations.

FIG. 4 shows an example of a graph representation of a computer program.

FIG. 5 shows an example of the performance of the described techniques.

Like reference numbers and designations in the various drawings indicate like elements.

### DETAILED DESCRIPTION

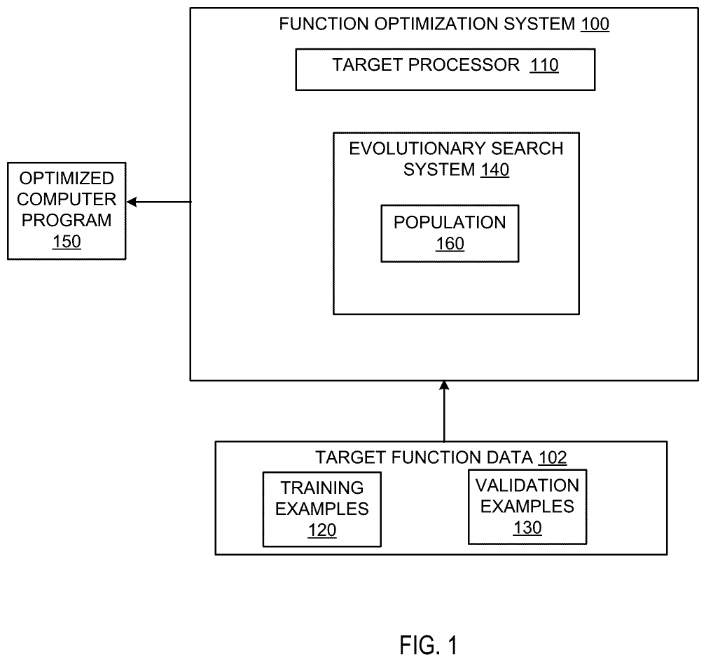

FIG. 1 shows an example function optimization system 100. The function optimization system 100 is an example of a system implemented as computer programs on one or more computers in one or more locations, in which the systems, components, and techniques described below can be implemented.

The function optimization system 100 is a system that optimizes a target function 102 for execution on a target processor 110.

The target processor 110 can generally be any appropriate computer processor that performs computations using memory and registers. For example, the target processor 110 can be a central processing unit (CPU) with a particular computer architecture, e.g., an x86 CPU or a RISC CPU. As another example, the target processor 110 can be an application-specific integrated circuit (ASIC).

In particular, the system 100 receives data specifying a target function 102 and generates as output an optimized computer program 150 that represents the target function 102 when executed on the target processor 110.

The target function 102 can be any appropriate function that is required to be computed as part of workloads executed on the target processor 110. For example, the target function 102 can be a transcendental function, i.e., a function that is not expressible as a finite combination of a set of algebraic computations. In other words, the transcendental function does not satisfy a polynomial equation whose coefficients are functions of the independent variable and that can be written using only basic operations, e.g., the operations of addition, subtraction, multiplication, and division. As a result, when computing the target function 102, the target processor 110 needs to approximate the target function 110 by composing instructions that can be carried out by the target processer 110.

Thus, because these instructions inherently have a limited precision, e.g., due to the use of floating-point number formats, different approximations of the same function 110 can have different accuracies and can be computed with different latency and throughput when executed by the target processor 110.

Generally, the data specifying the target function 102 can be any representation of the target function 102. For example, the system 100 can receive a mathematical formulation of the target function 102 or can simply receive a set of examples that each include an input to the function 102 and the output of the function 102.

By representing the target function 102 as a computer program, the system 100 can optimize the function 102 while optimizing directly for how floating-point computation is carried out by the target processor 110 and the corresponding compiler for the target processor 110.

In particular, the system 100 receives data specifying the target function 102 that is to be optimized for execution on the target processor 110.

The system 100 obtains a plurality of training examples 120 that each include an input to the target function and a target output of the target function and a plurality of validation examples 130 that each include an input to the target function and a target output of the target function.

For example, the system 100 can receive these examples or can generate these examples, e.g., using a mathematical formulation of the target function. As a particular example, when the target function 102 has a finite domain, the system can generate the target examples by computing the outputs of the target function (e.g., using the mathematical formulation of the target function) for a set of evenly spaced values within the finite domain.

The system 100 then uses the training examples 120 and the validation examples 130 to generate a computer program 150 that represents an optimized version of the target function 102 that is optimized for execution on the target processor 110.

The “optimized” version of the target function 102 generally refers to a set of operations that, when executed by the target processor 110, will cause the target processor 110 to generate outputs that approximate the target function 110 with high precision while optimizing the execution, e.g., optimizing the speed or latency of the execution.

As used in this specification, a “computer program” is a set of operations to be executed by the target processor 110 and that can be represented as a computational graph that includes a plurality of vertices and edges.

The plurality of vertices includes a plurality of internal vertices that each represent an instruction selected from a set of instructions for the target processor 110. The set of instructions that are represented by the internal vertices will generally depend on the target processor 110.

For example, each instruction can be an instruction to carry out an operation that can be efficiently performed in hardware by the processor 110. For example, for a CPU, the set of instructions represented by the internal vertices can be addition, subtraction, multiplication, and division.

The plurality of vertices also includes a plurality of external vertices that include an input vertex that represents an input to the target function 102 and one or more coefficient vertices that each represent a respective coefficient. The coefficients are internal values that are not received as input by the program but that are used as input to one or more of the operations performed by the computer program.

As part of generating the computer program, an evolutionary search system 140 within the system 100 repeatedly performs a set of search operations to update a population 160 of candidate computer programs.

Generally, the population 160 stores, for each candidate computer program, (i) data specifying the computer program, e.g., the computer code of the program or data specifying the computational graph representing the computer program, (ii) data specifying the precision of the candidate computer program on the validation examples 130, and (iii) a measure of performance of executing the candidate computer program on the target processor 110.

The measure of performance can be, e.g., specified by a user of the system 100 or can be pre-determined. The measure of performance can generally measure any aspect of executing a computer program on the target processor 110. For example, the performance measure can measure the speed of the candidate computer program or the latency of the candidate computer program when executed on the target processor 110.

At a high-level, the search operations include an outer loop of discrete optimization and an inner loop of continuous optimization. The outer loop discovers the symbolic structure of the program (e.g., “x×c0+c1”, though in practice much more complex than this), while the inner loop optimizes the floating-point coefficients (“c0” and “c1”). For example, the outer loop can evolve a population of programs by alternatingly selecting the best candidates and mutating them at random to generate more candidates.

Performing these search operations will be described in more detail below.

After performing the search operations, the system 100 selects, as the optimized computer program 150, one of the candidate computer programs from the population 160.

For example, the system 100 can select the candidate computer program based on the performances and precisions of the candidate computer programs in the population 160. As one example, the system 100 can select, from among the candidate computer programs in the population 160 that achieve at least a threshold precision, the candidate computer program that has the best performance measure.

After selecting the optimized computer program 150, the system 100 can generate, from the optimized computer program 150, executable machine code for the target processor 102. The system 100 can cause the target processor to execute the executable machine code to perform the target function 102. For example, a compiler for the target processor 102 can convert the optimized computer program 150 into executable machine code for the target processor 102.

Alternatively or in addition, the system 100 can provide the optimized computer program 150 or the executable machine code to another system for use in executing the target function 102 on the target process 110.

Alternatively or in addition, the optimized computer program 150 may be included in a programming language library. For example, the executable machine code may be included in a programming language library, such as a higher-level programming language library. Standard libraries provide building blocks of programs written in higher-level languages. By including the computer program 150 in a library, the performance of any computer program that accesses the computer program 150 in the library will be improved.

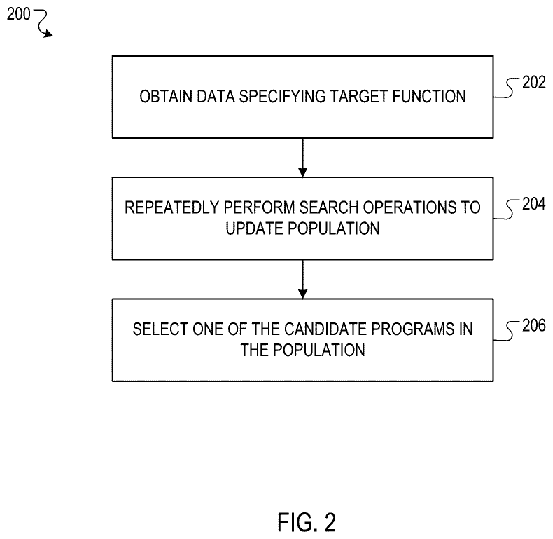

FIG. 2 is a flow diagram of an example process 200 for optimizing a function for execution on a target processor. For convenience, the process 200 will be described as being performed by a system of one or more computers located in one or more locations. For example, a function optimization system, e.g., the function optimization system 100 depicted in FIG. 1, appropriately programmed in accordance with this specification, can perform the process 200.

The system obtains data specifying a target function to be optimized for execution on a target processor (step 202).

Generally, the data specifying the target function includes a plurality of training examples that each include an input to the target function and a target output of the target function for the corresponding input. The data also includes a plurality of validation examples that each include an input to the target function and a target output of the target function for the corresponding input.

The system can obtain these examples in any of a variety of ways.

For example, the system can receive a mathematical formulation of the target function and then generate the training examples and the validation examples by applying the mathematical formulation to a set of inputs, e.g., randomly generated inputs or inputs selected to be representative of the domain of the function.

As another example, the system can receive the training examples and the validation examples as input, e.g., from another system or from a user.

As yet another example, the system can receive a single set of examples and can randomly partition the single set of examples into the training examples and the validation examples.

The system then generates a computer program that represents an optimized version of the target function that is optimized for execution on the target processor.

As described above, the computer program is represented as a computational graph that includes a plurality of vertices and edges, with the plurality of vertices including a plurality of internal vertices and a plurality of external vertices.

The plurality of internal vertices each represent an instruction selected from a set of instructions for the target processor.

The plurality of external vertices include an input vertex that represents an input to the target function, one or more coefficient vertices that each represent a respective coefficient, and an output vertex that represents an output of the target function.

Thus, the computer program can be used to compute an output that approximates the output of the target function by executing the instructions represented by the external vertices that are on a “path” from the input vertex that represents the input to the target function to the output vertex that represents the output of the target function. Because some of the external vertices will be connected by edges to internal vertices representing coefficients, the values of the coefficients impact the output generated by the computer program.

To generate the computer program, the system repeatedly performs a set of search operations to update the candidate computer programs in a population of candidate computer programs using the training examples and the validation examples (step 204).

The system can maintain the population as data stored in any appropriate memory, e.g., in one or more logical or physical memory devices.

For example, the system can initialize the population with one or more initial computer programs that include, e.g., one or more randomly generated computer programs, one or more identity programs, i.e., programs that map the input to the program to the output for the program, one or more initial computer programs that carry out the target function that the system is attempting to optimize, or some combination of the above.

The system can then repeatedly perform the search operations to update the candidate computer programs in the population until a termination criterion is satisfied, e.g., until a maximum number of updates have been performed, until the total number of candidate computer programs in the population reaches a maximum number, or some other termination criterion is satisfied.

After repeatedly performing the search operations, the system can select, as the optimized computer program, one of the computer programs in the population (step 206).

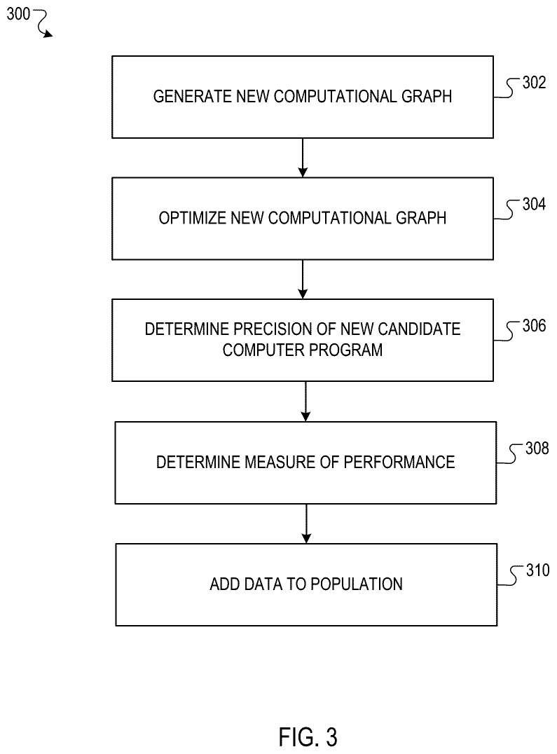

For example, the system can select the optimized computer program based on the precisions and performance measures of the candidates in the population as described above. FIG. 3 is a flow diagram of an example process 300 for performing a set of search operations. For convenience, the process 300 will be described as being performed by a system of one or more computers located in one or more locations. For example, a function optimization system, e.g., the function optimization system 100 depicted in FIG. 1, appropriately programmed in accordance with this specification, can perform the process 300.

As described above, the system can repeatedly perform the process 300 to update the population of candidate computer programs.

In some cases, the system can distribute the search operations so that operations are performed asynchronously by a plurality of worker devices. For example, each of the worker devices can repeatedly perform iterations of the process 300 asynchronously from the other workers. As another example, some of the worker devices can asynchronously perform certain ones of the steps of the process 300 while others of the worker devices can perform others of the steps of the process 300. This can allow the system to leverage parallelism and distributed computation in order to decrease the time required to perform the search.

The system generates a new candidate computational graph representing a new candidate computer program (step 302). As described, above, the new candidate computational graph has a respective plurality of candidate vertices and candidate edges, some of which represent coefficients.

For example, to generate the new candidate computational graph, the system can select a parent candidate computer program from the population and modify the computational graph representing the selected candidate computer program.

The system can modify the computational graph in any of a variety of ways.

For example, the system can modify the computational graph by breaking an existing edge in the computational graph representing the selected candidate computer program and inserting a new vertex into the computational graph. That is, given an edge that connects vertex A to vertex B, the system can insert a new vertex C that is connected by an edge to vertex A and by another edge to vertex B.

For example, the system can randomly select the edge to be broken from the existing edges in the graph. As another example, the system can select, at random, one of the existing vertices in the graph to be connected as an additional input to the new vertex. Additionally, the system can select, at random, whether the new vertex represents one of the instructions or represents a positive or negatively-valued coefficient. The system can perform this modification subject to the constraint that the modifications not result in a cycle being added to the graph.

As another example, the system can modify the computational graph by deleting an existing vertex in the computational graph representing the selected candidate computer program. The system can then also reconnect the output of the deleted vertex to one of the inputs to the vertex (selected at random).

As another example, the system can modify the computational graph by modifying an existing edge in the computational graph representing the selected candidate computer program to connect the existing edge to a different vertex in the computational graph representing the selected candidate computer program. That is, given an edge that connects vertex A to vertex B, the system can modify the edge so that the edge connects vertex A to a different vertex C. For example, the system can randomly select the edge and then randomly select an existing vertex for the randomly selected edge to be reconnected to.

To determine which, if any, of these modifications to apply, the system can randomly select one of the possible modifications, e.g., by sampling from a distribution over the modifications. As another example, the system can first determine, e.g., at a random, whether to apply any modification to the parent and, if so, then randomly sample one of the possible modifications in response to determining to apply any modifications to the parent computational graph.

In some cases, applying one or more of the above modifications can result in the graph including one or more vertices that are no longer on a path from a vertex representing the input to the target function to a vertex representing an output of the target function. Thus, the presence of these vertices in the computational graph does not impact the final output of the computer program. Thus, after modifying the computational graph representing the selected candidate computer program, the system can prune the computational graph representing the selected candidate computer program to remove any vertices that are no longer on the path from the vertex representing the input to the target function to the vertex representing an output of the target function.

The system can select the parent computer program in any of a variety of ways.

As one example, the system can select the parent computer program randomly from the candidate in the population.

As another example, the system can select the parent computer program based on the precisions and performances of the computer programs in the population.

For example, the system can apply an evolutionary search selection algorithm to the candidate computer programs from the population to select the parent computer program.

When the search operations are repeatedly performed asynchronously by a plurality of worker devices, the evolutionary search algorithm can be a distributed evolutionary search algorithm that partitions candidate computer programs into a plurality of fronts.

As a particular example of applying an evolutionary search selection algorithm, the system can classify the candidates into fronts in a process referred to as non-dominated sorting. These fronts are disjoint subsets of the population with the property that elements within a front cannot dominate each other. A program p1 “dominates” another program p2 if and only if p1 is better than p2 at one objective and no worse at all others, where the objectives are precision r and the measure of performance s, as described above. That is, p1 dominates p2 if and only if:

$$( r ( p 1 ) \geq r ( p 2 ) ∧ ( s ( p 1 ) \geq s ( p 2 ) ) ∧ ( r ( p 1 ) > r ( p 2 ) ∨ s ( p 1 ) > s ( p 2 ) )$$

Thus, the first front contains all the programs not dominated by any other and is therefore the Pareto front of the population. The next front contains all the remaining programs not dominated by any other remaining program, and so on.

The fronts are therefore ordered. The system can then follow this order to select the “parent” programs that will be used to generate the next set of candidate programs. For example, the system can select a fixed number K of parent programs by iterating through the fronts and adding all of the candidates in the front to the set of parent programs until the current front contains more than K-k candidates, where k is the total number of candidates in the fronts that are before the current front in the order. The system can then add candidates from the current front to the set of parent programs in any of a variety of ways, e.g., using crowding procedure used to favor programs so that the population remains evenly spread in precision-speed space, e.g., based on distances in the precision-speed space.

In some cases, however, performing this non-dominated sorting process can be computationally intensive. In particular, the computational complexity of this process scales as P², where P is the number of candidates in the population, therefore becoming a bottleneck for large populations.

To address this, the system can embed this selection step in a fully distributed system by performing the selection step in a distributed fashion by the worker devices instead of on a centralized server. Since the sample size becomes much smaller than P, the workers can perform this step quickly. Moreover, these workers can now operate asynchronously, without imposing a selection semaphore that may result in idle workers and under-utilization of resources.

To perform distributed selection, each worker receives a sample of 2S programs from other workers, where S is a fixed number of parents to be generated by each worker at each iteration. The worker then carries out the selection resulting in S parents. The worker then performs mutation and evaluation of each selected parent as described above to produce 2S children with corresponding precisions and performance measures, which are emitted for other workers to use.

The system optimizes the new candidate computational graph using the plurality of training examples to determine optimized values for one or more coefficients represented by one or more coefficient vertices included in the respective plurality of candidate vertices (step 304).

That is, the system optimizes the values of the coefficients represented by the coefficient vertices to improve the precision of the program represented by the new computational graph on the plurality of training examples.

For example, to optimize the new candidate computational graph, the system can compile, using a compiler for the target processor, the new candidate computational graph to generate a compiled program. Examples of compilers that can be used to compile computational graphs for execution on various target processors include the XLA compiler and the LLVM compiler.

The system can then determine optimized values for the one or more coefficients by optimizing a precision of the compiled program when executed on the target processor.

As a particular example, the system can train the coefficients to maximize the negative maximum relative error over the training examples.

The system can measure the relative error in any of a variety of ways, depending on the type of target function.

For example, for real-valued target functions, the system can measure the error for a given function ƒ on an input y given a target output g(x) as |g(x)−ƒ(x)|/|g(x)|.

As another example, for float-valued functions, the system can measure the error as |g(x)−ƒ(x)|/ulp(g(x)), where ulp(y) denotes one unit-in-the-last-place (ULP) of y. A ULP is defined as the distance to the closest larger value representable as a floating-point number.

The system can train the coefficients in any of a variety of ways. As one example, the system can train the coefficients using an evolutionary algorithm. As a particular example of this, the system can maintain a population of candidate solutions, i.e., candidate solutions that each assign a respective value to each of the coefficients. For example, the system can maintain each solution as a vector of coefficients, i.e., a vector that includes a respective value for each of the coefficients. The system can then iteratively improve the population by replacing it with a new population. For example, the system can generate the new population at a given iteration as a random gaussian perturbation with the mean of the previous population and a covariance matrix that is adapted to the distribution of the population.

Making use of an evolutionary strategy allows the system to avoid assumptions about real-valued arithmetic that do not hold for floating point numbers, e.g., float32 numbers, that would be required if doing gradient descent in a continuous space.

Once the system has determined the optimized values of the coefficients, the system determines a precision of the new candidate computer program on the plurality of validation examples when the one or more coefficients have the optimized values (step 306). That is, the system can determine, for each of the validation examples, the output of the new candidate compute program when executed on the input in the validation example. The system can then determine the precision of the new candidate computer program by comparing the outputs for the validation examples to the corresponding target outputs in the training examples.

For example, to determine the precision, the system can compile, using the compiler for the target processor, the new candidate computational graph bound with the optimized values of the one or more coefficients to generate an optimized compiled program. If the system has already compiled the new candidate computational graph bound with the optimized values of the one or more coefficients, the system can re-use the optimized compiled program rather than re-compiling the program.

The system can then determine a precision of the optimized compiled program on the plurality of validation examples by executing the optimized compiled program on each of the validation examples to generate the outputs for the validation examples mentioned above.

The system determines a measure of performance of executing the new candidate computer program on the target processor (step 308). As described above, the measure of performance can measure any of a variety of properties of the execution of the program on the target processor. As one example, the measure of performance can measure the speed or latency of the candidate program when executed on the target processor.

To determine the measure of performance, the system can measure the one or more properties, e.g., the speed or the latency of the optimized compiled program, when processing the plurality of validation examples using the optimized compiled program.

The system adds data specifying (i) the new candidate computational graph, (ii) the precision of the new candidate computer program, and (iii) the performance of executing the new candidate computer program to the population of candidate computer programs (step 310).

Generally, because the search is done in the space of the compiled programs, the system ensures that the search accounts for compiler effects that are caused by the compilation of the computational graph, e.g., compiler determinations such as operation fusion and output reuse, that impact precision and performance at execution time.

Moreover, because precision and performance are measured specific to the target processor, the precision and performance take into consideration processor-specific execution effects, e.g., hardware decisions such as pipelining, prefetching, and speculative execution, that impact precision and performance.

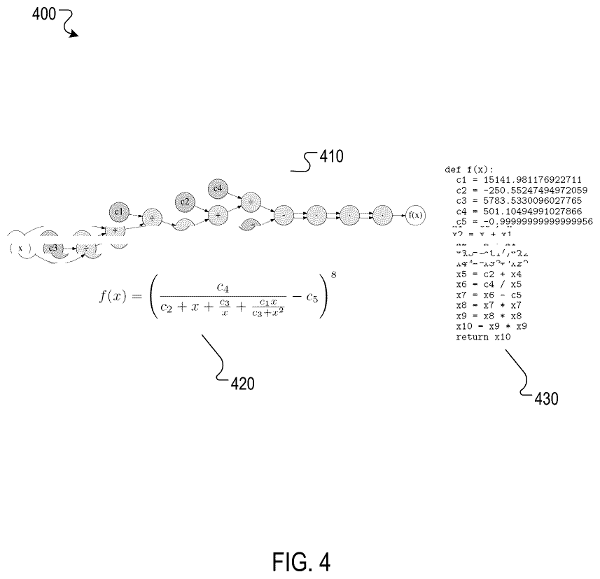

FIG. 4 shows an example 400 of a graph representation 410 of a computer program for computing the function g(x)=24. In other words, the graph representation 410 is a representation of a computer program that executes a function ƒ(x) that is a real-valued approximation of g(x).

In particular, the example 400 shows a graph representation 410 determined using the described techniques of a computer program that computes an output that approximates g(x) using 10 operations.

Thus, the graph representation 410 includes an input node, an output node, and ten operation nodes. The graph representation 410 also includes five coefficient nodes.

The example 400 also shows a mathematical formulation 420 of the function ƒ(x) executed by the computer program as well as pseudo-code 430 for the computer program that shows the values of the coefficients determined by the system.

During the search process, the system can repeatedly modify candidate computer programs to arrive at the graph representation 410. For example, the system can modify the values represented by the coefficient nodes, i.e., as part of optimizing a given candidate program. As another example, the system can modify how many operations nodes there, the operations represented by the operation nodes, and which values each operation node operates on as part of modifying an existing candidate to generate a new candidate.

By repeatedly modifying the candidates in the population and then selecting the computer program represented by the graph representation 410 as the optimized representation, the system can arrive at a program that effectively approximates the function g(x) when executed on a specific target processor.

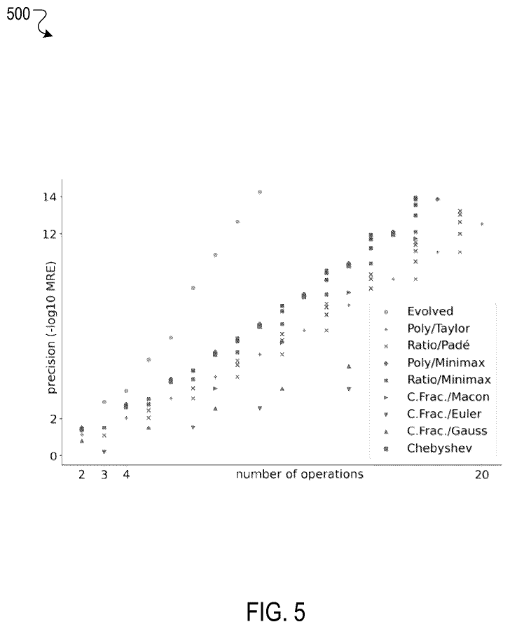

FIG. 5 shows an example 500 of the performance of the described techniques. In particular, the example 500 shows the performance of the described techniques (“Evolved”) relative to a set of baseline, previously state-of-the-art techniques for approximating the function g(x)=2^{x} when executed on a particular target processor for different numbers of operations. The performance is shown in terms of the precision when executed on the target processor (as the negative logarithm of the mean relative error). As can be seen from the example 500, the described techniques outperform the existing techniques for each given number of operations by many orders of magnitude in precision (considering the log-scale in the ordinate axis).

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, e.g., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers, the method comprising:
obtaining data specifying a target function to be optimized for execution on a target processor, the data specifying the target function comprising:
a plurality of training examples that each comprise an input to the target function and a target output of the target function, and
a plurality of validation examples that each comprise an input to the target function and a target output of the target function; and
generating a computer program that represents an optimized version of the target function that is optimized for execution on the target processor, the computer program being represented as a computational graph comprising a plurality of vertices and edges, the plurality of vertices comprising a plurality of internal vertices that each represent an instruction selected from a set of instructions for the target processor and a plurality of external vertices that include an input vertex that represents an input to the target function, one or more coefficient vertices that each represent a respective coefficient, and an output vertex that represents an output of the target function, the generating comprising repeatedly performing search operations comprising:
generating a new candidate computational graph representing a new candidate computer program, the new candidate computational graph comprising a respective plurality of candidate vertices and candidate edges;
optimizing the new candidate computational graph using the plurality of training examples to determine optimized values for one or more coefficients represented by one or more coefficient vertices included in the respective plurality of candidate vertices;
determining a precision of the new candidate computer program on the plurality of validation examples when the one or more coefficients have the optimized values;
determining a measure of performance of executing the new candidate computer program on the target processor; and
adding data specifying the new candidate computational graph, the precision of the new candidate computer program, and the performance of executing the new candidate computer program to a population of candidate computer programs.

2. The method of claim 1, further comprising:
causing the target processor to execute the computer program to perform the target algorithm.

3. The method of claim 1, wherein generating a computer program that represents an optimized version of the target function that is optimized for execution on the target processor further comprises:
after repeatedly performing the operations, selecting the computer program from the population based on the performances and precisions of the candidate computer programs in the population.

4. The method of claim 1, wherein generating a new candidate computational graph representing a new candidate computer program comprises:
selecting a candidate computer program from the population; and
modifying a computational graph representing the selected candidate computer program.

5. The method of claim 4, wherein modifying a computational graph representing the selected candidate computer program comprises:
breaking an existing edge in the computational graph representing the selected candidate computer program and inserting a new vertex into the computational graph.

6. The method of claim 4, wherein modifying a computational graph representing the selected candidate computer program comprises:
deleting an existing vertex in the computational graph representing the selected candidate computer program.

7. The method of claim 4, wherein modifying a computational graph representing the selected candidate computer program comprises:
modifying an existing edge in the computational graph representing the selected candidate computer program to connect the existing edge to a different vertex in the computational graph representing the selected candidate computer program.

8. The method of claim 1, wherein generating a new candidate computational graph representing a new candidate computer program further comprises:
after modifying a computational graph representing the selected candidate computer program, pruning the computational graph representing the selected candidate computer program to remove any vertices that are no longer on a path from a vertex representing the input to the target function to a vertex representing an output of the target function.

9. The method of claim 4, wherein selecting a candidate computer program from the population comprises:
selecting a candidate computer program from the population based on the precisions and performances of the computer programs in the population.

10. The method of claim 9, wherein selecting a candidate computer program from the population based on the precisions and performances of the computer programs in the population comprises:
applying an evolutionary search selection algorithm to the candidate computer programs from the population.

11. The method of claim 1, wherein the target processor is a central processing unit (CPU).

12. The method of claim 1, wherein the target processor is an ASIC.

13. The method of claim 1, wherein the search operations are repeatedly performed asynchronously by a plurality of worker devices.

14. The method of claim 13, when dependent on claim 10, wherein the evolutionary search algorithm is a distributed evolutionary search algorithm that partitions candidate computer programs into a plurality of fronts.

15. The method of claim 1, wherein optimizing the new candidate computational graph using the plurality of training examples to determine optimized values for one or more coefficients represented by one or more coefficient vertices included in the respective plurality of candidate vertices comprises:
compiling, using a compiler for the target processor, the new candidate computational graph to generate a compiled program; and
determining optimized values for the one or more coefficients by optimizing a precision of the compiled program.

16. The method of claim 1, wherein determining a precision of the new candidate computer program on the plurality of validation examples when the one or more coefficients have the optimized values comprises:
compiling, using a compiler for the target processor, the new candidate computational graph bound with the optimized values of the one or more coefficients to generate an optimized compiled program; and
determining a precision of the optimized compiled program on the plurality of validation examples.

17. The method of claim 16, wherein determining a measure of performance of executing the new candidate computer program on the target processor comprises:
measuring a speed or a latency of the optimized compiled program when processing the plurality of validation examples.

18. A system comprising:
one or more computers; and
one or more storage devices storing instructions that, when executed by the one or more computers, cause the one or more computers to perform operations comprising:
obtaining data specifying a target function to be optimized for execution on a target processor, the data specifying the target function comprising:
a plurality of training examples that each comprise an input to the target function and a target output of the target function, and
a plurality of validation examples that each comprise an input to the target function and a target output of the target function; and
generating a computer program that represents an optimized version of the target function that is optimized for execution on the target processor, the computer program being represented as a computational graph comprising a plurality of vertices and edges, the plurality of vertices comprising a plurality of internal vertices that each represent an instruction selected from a set of instructions for the target processor and a plurality of external vertices that include an input vertex that represents an input to the target function, one or more coefficient vertices that each represent a respective coefficient, and an output vertex that represents an output of the target function, the generating comprising repeatedly performing search operations comprising:
generating a new candidate computational graph representing a new candidate computer program, the new candidate computational graph comprising a respective plurality of candidate vertices and candidate edges;
optimizing the new candidate computational graph using the plurality of training examples to determine optimized values for one or more coefficients represented by one or more coefficient vertices included in the respective plurality of candidate vertices;
determining a precision of the new candidate computer program on the plurality of validation examples when the one or more coefficients have the optimized values;
determining a measure of performance of executing the new candidate computer program on the target processor; and
adding data specifying the new candidate computational graph, the precision of the new candidate computer program, and the performance of executing the new candidate computer program to a population of candidate computer programs.

19. One or more non-transitory computer-readable storage media storing instructions that when executed by one or more computers cause the one or more computers to perform operations comprising:
obtaining data specifying a target function to be optimized for execution on a target processor, the data specifying the target function comprising:
a plurality of training examples that each comprise an input to the target function and a target output of the target function, and
a plurality of validation examples that each comprise an input to the target function and a target output of the target function; and
generating a computer program that represents an optimized version of the target function that is optimized for execution on the target processor, the computer program being represented as a computational graph comprising a plurality of vertices and edges, the plurality of vertices comprising a plurality of internal vertices that each represent an instruction selected from a set of instructions for the target processor and a plurality of external vertices that include an input vertex that represents an input to the target function, one or more coefficient vertices that each represent a respective coefficient, and an output vertex that represents an output of the target function, the generating comprising repeatedly performing search operations comprising:
